(19) United States
(12) Patent Application Publication
(10) Pub. No.: US 2018/0051113 A1
(43) Pub. Date: Feb. 22, 2018

(54) MELT-PROCESSABLE THERMOSET POLYMERS, METHOD OF SYNTHESIS THEREOF AND USE IN FUSED FILAMENT FABRICATION PRINTING

(71) Applicants: Board of Regents, The University of Texas System, Austin, TX (US); Adaptive 3D Technologies, Dallas, TX (US)

(72) Inventors: Kejia Yang, Dallas, TX (US); Benjamin R. Lund, Wylie, TX (US); Ronald Smaldone, Plano, TX (US); Walter Voit, Dallas, TX (US)

(21) Appl. No.: 15/457,243

(22) Filed: Mar. 13, 2017

Related U.S. Application Data
(60) Provisional application No. 62/377,789, filed on Aug. 22, 2016.

(51) Int. Cl. C08F 220/28; B29C 67/00; B33Y 10/00; B33Y 30/00; B33Y 70/00; B29C 71/02

(52) U.S. Cl. CPC C08F 220/28; B29C 67/0055; B33Y 10/00; B29K 2105/0067; B33Y 70/00; B29C 71/02; B33Y 30/00

(57) ABSTRACT

A melt-processable thermoset polymer comprising monomers cross-linked together by furan-maleimide Diels Alder adduct covalent bonds. At least about 1 percent of the furan-maleimide Diels Alder adduct covalent bonds of the polymer are de-cross-linked by a retro Diels Alder reaction at a temperature in a range from about 90° C. and less than about 300° C. A method of synthesizing, a filament fabrication printer for printing, and a method of printing, the melt-processable thermoset polymer are also disclosed.

### CROSS-REFERENCES TO RELATED APPLICATION

This Application claims the benefit under 35 U.S.C. §119(e) of U.S. Provisional Patent Application No. 62/377,789 filed Aug. 22, 2016, which is incorporated herein by reference in its entirety as if fully set forth herein.

### TECHNICAL FIELD

This application is directed, in general, to thermoset polymers and more specifically melt-processable forms of such polymers, methods of synthesis, and, using such polymers in fused filament fabrication printing and to printers adapted to facilitate such printing.

### BACKGROUND

Fused filament fabrication (FFF) printing is an increasingly accessible, rapid, low cost form of additive manufacturing technology for 3-dimensional (3D) polymer printing. Often, however, the thermoplastic polymers that are used for FFF printed parts lack the same isotropic toughness and reliability of injection or compression molded parts due to the poor interlayer adhesion between printed filaments leading to poor mechanical properties in the printed parts. Efforts have been made to develop thermoset polymers, with their generally better thermal stability, chemical resistance and mechanical properties than thermoplastics, for FFF printing, including synthesizing cross-linked melt-processable forms of thermoset polymers. Such efforts, however, have produced thermoset polymers which lead to FFF printed products with significant mechanical anisotropy, e.g., direction-dependent mechanical properties, such as varying toughness losses when deformed against the printed filament grain.

Thus, there is a continuing need to develop new melt-processable forms of thermoset polymers that are suitable for FFF printing manufacturing technologies.

### SUMMARY

The present disclosure provides in one embodiment, a melt-processable thermoset polymer comprising monomers cross-linked together by furan-maleimide Diels Alder adduct covalent bonds. At least about 1 percent of the furan-maleimide Diels Alder adduct covalent bonds of the polymer are de-cross-linked by a retro Diels Alder reaction at a temperature in a range from about 90° C. and less than about 300° C.

Another embodiment of the disclosure is a method of synthesizing a melt-processable thermoset polymer, comprising cross-linking monomers together including forming furan-maleimide Diels Alder adduct covalent bonds. At least about 1 percent of the furan-maleimide Diels Alder adduct covalent bonds of the polymer are de-cross-linked by a retro Diels Alder reaction at temperature in a range from about 90° C. and less than about 300° C.

Another embodiment is a filament fabrication printer comprising a syringe extruder, a needle connected to an outlet of the syringe extruder and a heating coil wrapped around the syringe extruder. The heating coil is configured to heat a melt-processable thermoset polymer held in the syringe extruder to a temperature in a range from about 90° C. and less than about 300° C.

Still another embodiment of the disclosure is a method of fused filament fabrication printing. The method comprises loading a melt-processable thermoset polymer into a syringe extruder and forming a melt of the melt-processable thermoset polymer by heating the syringe extruder to a temperature in a range from about 90° C. and less than about 300° C. The method comprises extruding the melt through a needle connected to an outlet of the syringe extruder to deposit a printed thermoset polymer part onto a print bed.

### BRIEF DESCRIPTION OF DRAWINGS

For a more complete understanding of the present disclosure, reference is now made to the following detailed description taken in conjunction with the accompanying FIGS., in which:

FIG. 1 present schematic representations of example Diels-Alder and retro-Diels Alder reactions between: (A) a diene and dienphile functionalized reactants to form a Diels-Alder adduct, (B) 1,3 butadiene and ethylene to form cyclohexene and (C) a furan functionalized reactant and a maleimide functionalized reactant;

FIG. 2 present schematic diagrams of an embodiment of a furan-maleimide Diels-Alder and retro-Diels Alder reaction scheme between a polymer with furan functionalized pendant groups and a bismaleimide functionalized crosslinking reactant to form reversibly cross-linked polymers in accordance with the disclosure;

FIG. 3 present diagrams of another embodiment of a furan-maleimide Diels-Alder and retro-Diels Alder reaction scheme between a monomer with tri-furan functionalized pendant groups and a bismaleimide functionalized monomer to form reversibly cross-linked polymers in accordance with the disclosure;

FIG. 4 presents a schematic representations of: A) a polymerization reaction between Ethyl MethAcrylate (EMA) and Furfuryl MethAcrylate (FMA) to form a Poly(FMA-co-EMA) polymer and B) Methylenedi-phenylene bismaleimide (MPBMI) crosslinkers in accordance with the reaction scheme shown in FIG. 2;

FIG. 5 presents example Differential scanning calorimetry (DSC) scans of: an embodiment of the Poly(FMA-co-EMA) polymer and an embodiment of the Poly(FMA-co-EMA) polymer after crosslinking with MPBMI as depicted in FIG. 4 and in accordance with the reaction scheme shown in FIG. 2;

FIG. 6 presents example dynamic mechanical analysis (DMA) scans of an embodiment of the Poly(FMA-co-EMA) polymer, and, an embodiment of the Poly(FMA-co-EMA) polymer after crosslinking with MPBMI as depicted in FIG. 4 and in accordance with the reaction scheme shown in FIG. 2;

FIG. 7 presents schematic representations of: A) tri-furan functionalized monomer (TMPA-3F) and B) a bismaleimide monomer (BMI-1700) which when reacted in a furan-maleimide Diels-Alder reaction to form a thermoset polymer in accordance with the reaction scheme shown in FIG. 3;

FIG. 8 presents a schematic diagram of a reaction scheme to synthesize the tri-furan functionalized monomer (TMPA-3F);

FIG. 9 presents an example ¹H NMR spectrum obtained as part of verifying the identity of the tri-furan functionalized compound (TMPA-3F) synthesized as described in the context of FIG. 8;

FIG. 10 presents example DSC scans of an embodiment of the thermoset polymer (3F-2M) formed in the furan-maleimide Diels-Alder reaction of the reactants shown in FIG. 7 in accordance with the reaction scheme shown in FIG. 3;

FIG. 11 presents example DMA scans of the thermoset polymer (3F-2M) formed in the furan-maleimide Diels-Alder reaction of the reactants shown in FIG. 7 in accordance with the reaction scheme shown in FIG. 3;

FIG. 12 presents example cut-out dog-bone samples showing cut along different directions with different angles between the tension direction and the printed layer direction as shown in the figure, for FFF-printed polymer layers of the thermoset polymer (3F-2M) formed in the furan-maleimide Diels-Alder reaction of the monomer shown in FIG. 7, for use in tensile testing in accordance with the disclosure;

FIG. 13 presents example toughness measurements of the dog-bone samples described in the context of FIG. 12;

FIG. 14 presents example DSC and DMA scans of embodiments of NinjaFlex® (A and B, respectively), SemiFlex™ (C and D, respectively) and the thermoset polymer (3F-2M) synthesized as disclosed herein (E and F respectively);

FIG. 15 presents example stress-strain curves for dog-bone compression molded and FFF printed sample embodiments of: A) NinjaFlex®, B) SemiFlex™ and C) the thermoset polymer (3F-2M);

FIG. 16 shows detailed photographic cross-section views of portions FFF printed parts from: A) NinjaFlex®, B) SemiFlex™ and C) the thermoset polymer (3F-2M), the detailed views corresponding to the circled portion shown in FIG. 16D;

FIG. 17A presents a photograph of a printer adapted to FFF print the Diels-Alder synthesized thermoset polymer (3F-2M);

FIG. 17B presents a detailed photographic view of the syringe printer head portion of the printer depicted in FIG. 17A;

FIG. 18 presents schematic representations of additional furan functionalized monomers (PETTA-4F, TCMDA-2F and ICN-3F) and maleimide functionalized monomer (bismaleimido tricyclodecane and ICN-3M) which, when reacted in a furan-maleimide Diels-Alder reaction, can form a thermoset polymer in accordance with the reaction scheme shown in FIG. 3;

FIG. 19 presents a flow diagram of an example method of synthesizing a melt-processable thermoset polymer, including any of the melt-processable thermoset polymer embodiments disclosed in the context of FIGS. 1-18; and

FIG. 20 presents a flow diagram of an example method of fused filament fabrication printing, including printing a thermoset polymer part that includes any of the melt-processable thermoset polymer embodiments disclosed in the context of FIGS. 1-19.

### DETAILED DESCRIPTION

Embodiments of the present disclosure benefit from the use of furan-maleimide Diels-Alder (fmDA) chemistry to synthesize melt-processable thermoset polymers showing low mechanical anisotropy in FFF printed polymer parts. The reversibility of the cross-links formed in such polymers, a type of dynamic covalent furan-maleimide Diels Alder bond, facilitates these thermoset polymers to be melt-processable at elevated temperatures (e.g., greater than 90° C. in some embodiments), similar to thermoplastic polymers. After the polymers are deposited onto a print bed, the de-cross-linked polymers start to crosslink via Diels-Alder reaction at lower temperatures (e.g., less than about 90° C. in some embodiments). The cross-links can form in all directions within the printed parts, including within and between the printed layers, resulting in improved homogeneity of cross-linking throughout the printed part. This, in turn, beneficially reduces the mechanical anisotropy in the printed parts.

It was surprising that the melt-processable thermoset polymers disclosed herein could be made suitable for FFF printing because the cross-links formed within a printed network of the thermoset polymers are not completely reversible at a given temperature, but rather are in equilibrium. Even though the equilibrium is increasingly driven towards the reactants from the Diels-Alder adducts at higher temperature, only about 20%-30% of fmDA linkages in some embodiments undergo retro-cycloaddition at temperatures suitable for FFF printing using commercial printers (e.g., less than about 300° C. in some embodiments). Moreover such higher temperatures increase the risk of promoting side reactions, such as aromatization of the DA adducts, ring-opening of furfuryl rings and homopolymerization of maleimides, causing the loss of reversibility of cross-links, as well as polymer degradation. Therefore, a balance had to be obtained between maximal disassociation and minimal degradation of the reactants. A new FFF printer and method of FFF printing to facilitate achieving this balance are disclosed herein.

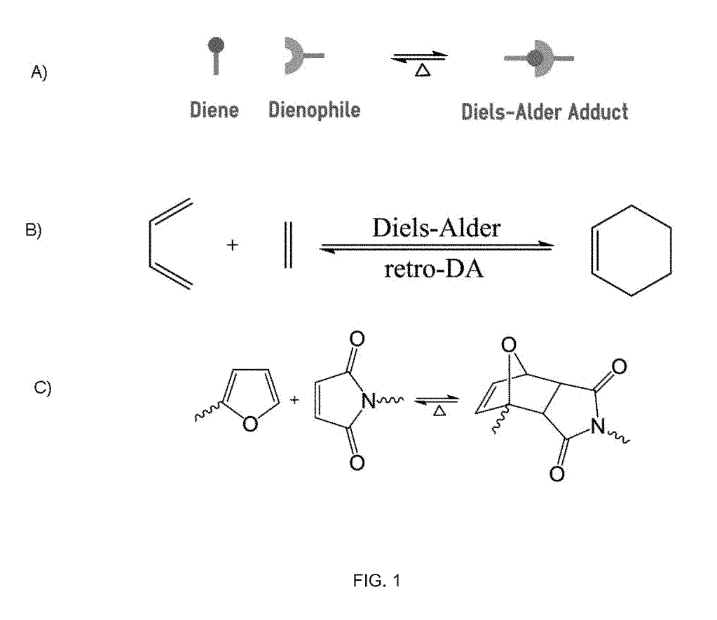

The Diels-Alder reaction is a [4+2] cycloaddition between a dienophile and a diene. Some variants of the DA reaction are thermally reversible through a retro-DA reaction, which can occur at higher temperatures. FIG. 1 present schematic representations of example Diels-Alder and retro-Diels Alder reactions between: (A) a diene and dienphile functionalized reactants to form a Diels-Alder adduct, (B) 1,3 butadiene and ethylene to form cyclohexene and (C) a furan functionalized reactant and a maleimide functionalized reactant.

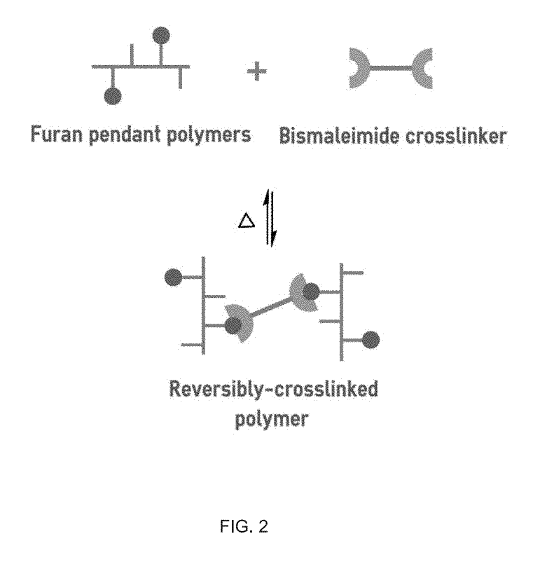

FIG. 2 present schematic diagrams of an embodiment of a furan-maleimide Diels-Alder and retro-Diels Alder reaction scheme between a polymer with furan functionalized pendant groups and a bismaleimide functionalized crosslinking reactant to form reversibly cross-linked polymers in accordance with the disclosure.

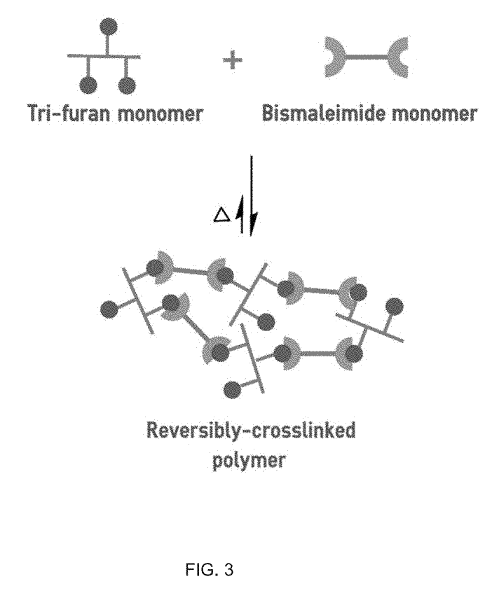

FIG. 3 present diagrams of another embodiment of a furan-maleimide Diels-Alder and retro-Diels Alder reaction scheme between a monomer with tri-furan functionalized pendant groups and a bismaleimide functionalized monomer to form reversibly cross-linked polymers (3F-2M) in accordance with the disclosure.

Polymers samples were synthesized according to one of the reaction schemes shown in FIGS. 2 and 3 and the mechanical properties of some of these polymers samples, both neat (i.e., non-printed) and as FFF printed polymer parts were measured and compared to select commercially available polymers intended for use in FFF printing, as further described below.

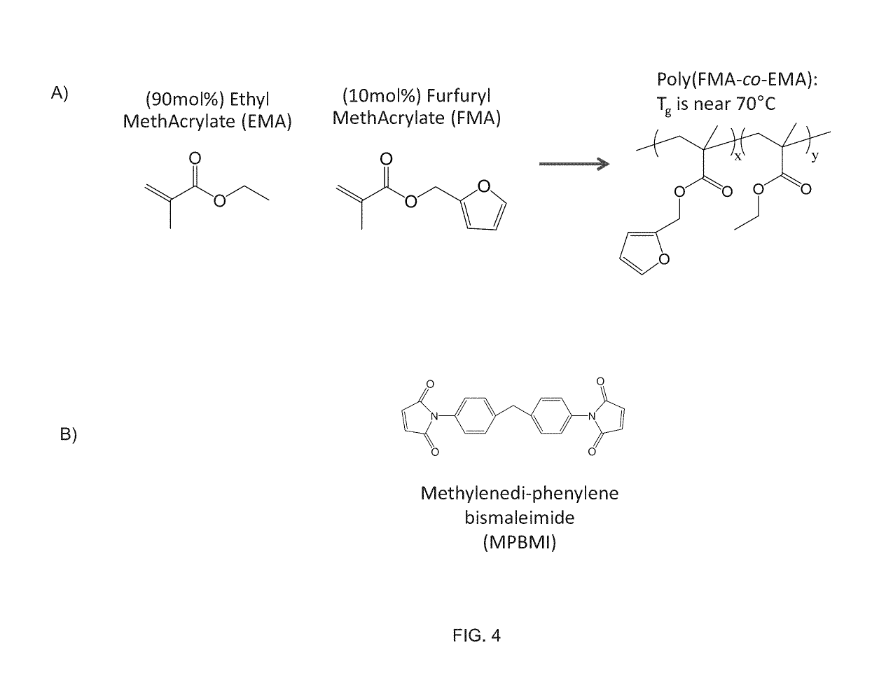

FIG. 4 presents a schematic representation of: A) a polymerization reaction between Ethyl MethAcrylate (EMA) and Furfuryl MethAcrylate (FMA) to form a Poly(FMA-co-EMA) polymer and B) Methylenedi-phenylene bismaleimide (MPBMI) cross-linkers in accordance with the reaction scheme shown in FIG. 2.

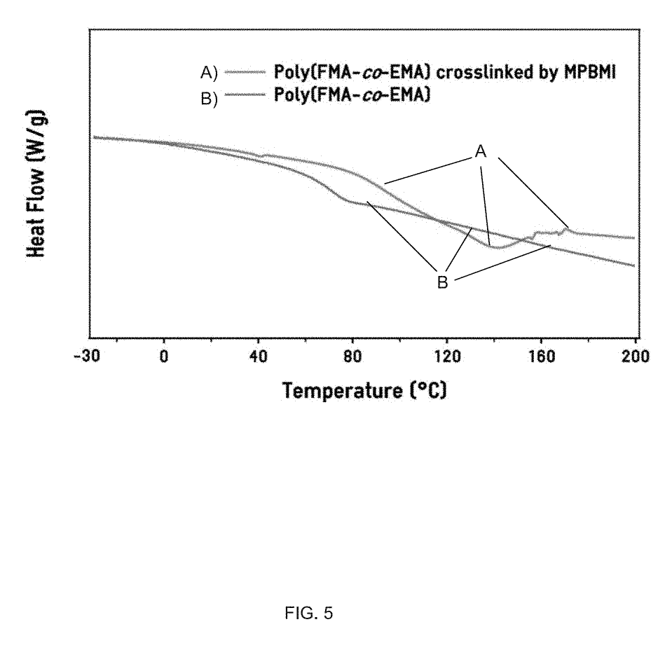

FIG. 5 presents example Differential scanning calorimetry (DSC) scans of: an embodiment of the Poly(FMA-co-EMA) polymer and an embodiment of the Poly(FMA-co-EMA) polymer after crosslinking with MPBMI in accordance with the reaction scheme shown in FIG. 2.

DSC was performed on a Mettler Toledo DSC-1. Sample size was limited between 8-10 mg. Samples were tested under nitrogen at 50 mL/min and at a heating rate of 10° K/min except the cooling cycle of 3F-2M was at 1° K/min to ensure complete Diels-Alder reaction during the slow cooling.

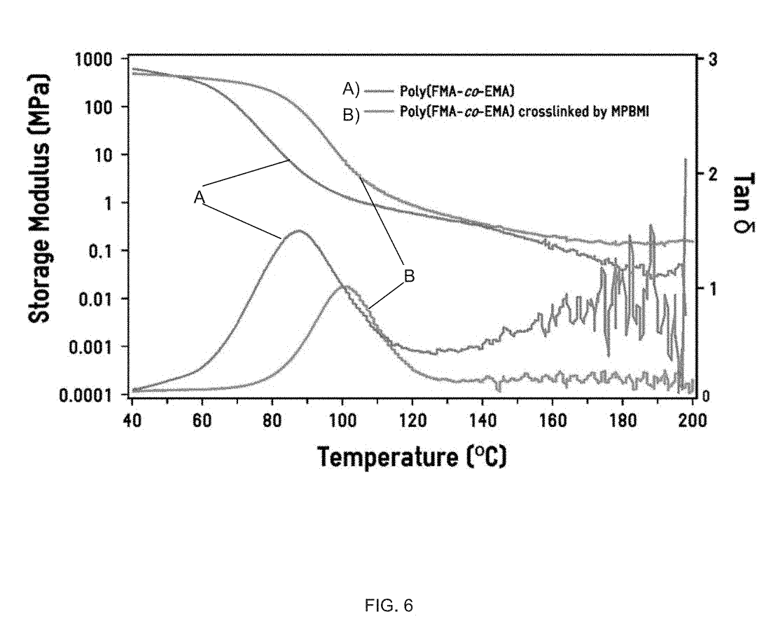

FIG. 6 presents example dynamic mechanical analysis (DMA) scans of: an embodiment of the Poly(FMA-co-EMA) polymer and an embodiment of the Poly(FMA-co-EMA) polymer after crosslinking with MPBMI as depicted in FIG. 4 and in accordance with the reaction scheme shown in FIG. 2.

DMA was performed on a Mettler Toledo DMA 861e/SDTA. Samples were cut into rectangular prisms approximately 25 mm long, 3 mm wide and 1 mm wide. The sinusoidal mode of deformation for the DMA was tension, with a frequency of 1 Hz, 5 N force amplitude and 21 μm displacement amplitude. Samples were tested in air at a heating rate of 2° K/min. At least three samples were tested for each composition.

The Poly(FMA-co-EMA) polymer displayed limited reversibility of the Diels-Alder reaction in a solvent-free environment.

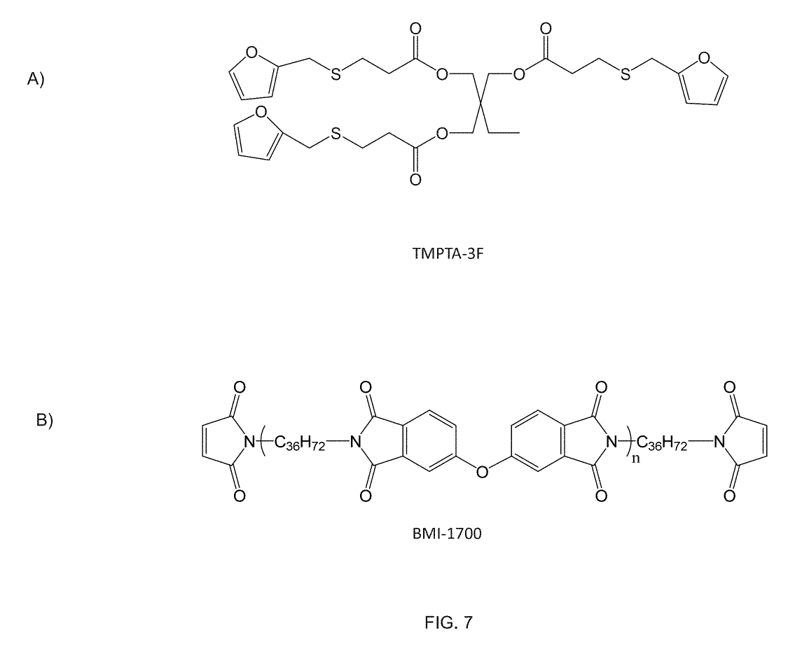

FIG. 7 presents schematic representations of: A) tri-furan functionalized monomer (TMPA-3F) and B) a bismaleimide monomer (e.g., BMI-1700) which when reacted in a furan-maleimide Diels-Alder reaction to form a thermoset polymer in accordance with the reaction scheme shown in FIG. 3.

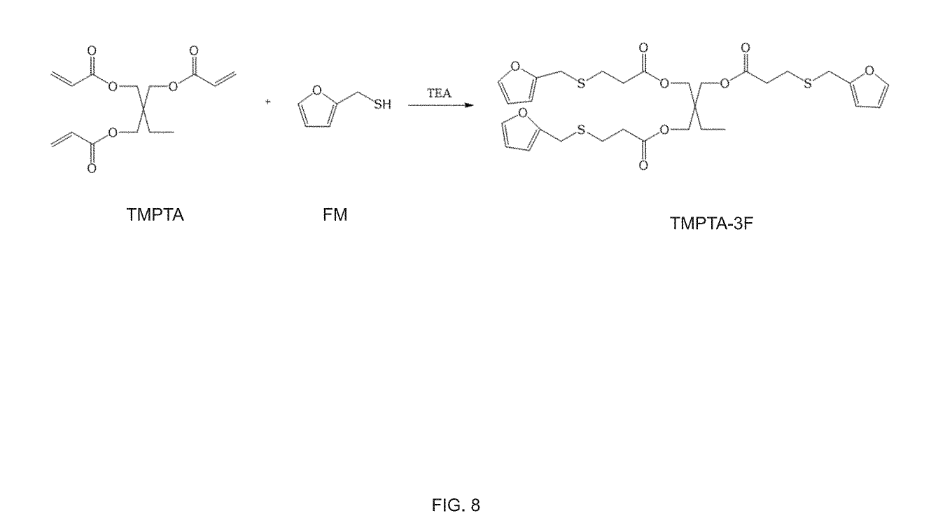

FIG. 8 presents a schematic representation of a reaction scheme to synthesize the tri-furan functionalized trimethylolpropane triacrylate monomer (TMPA-3F). Trimethylolpropane triacrylate (TMPTA) (1 g, 3.37 mmol) was dissolved in Dichloromethane (DCM) (2 mL) in the presence of triethylamine (TEA) (0.15 mL) in a 100 mL round bottom flask. Furfuryl mercaptan (FM) (1.2 g, 9.28 mmol) was added to the solution and the mixture was stirred in an ice bath for 1 h and stirring was continued for 16 h at 40° C., followed by the removal of the solvent in vacuo. The excess FM was removed under high vacuum to produce a pale yellow viscous liquid (yield=87.38%).

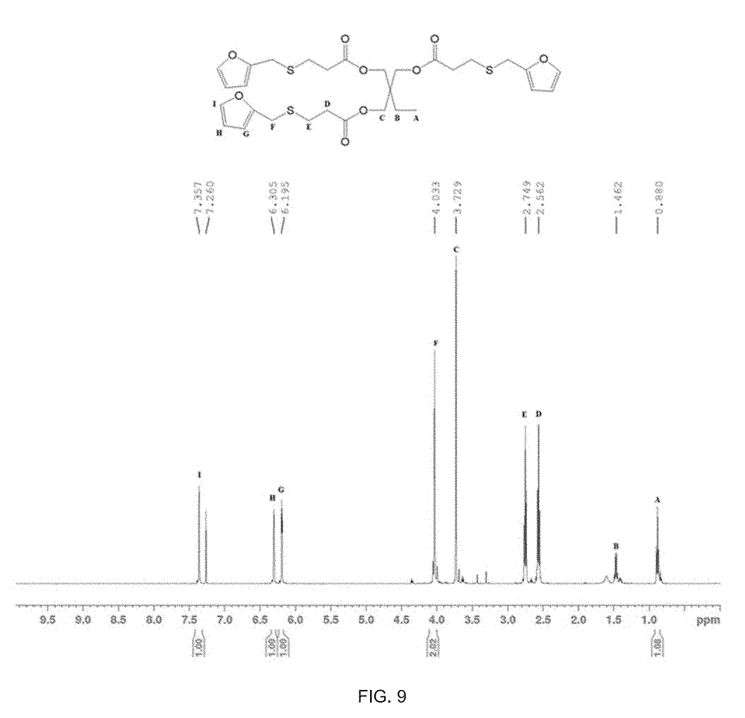

FIG. 9 presents an example ¹H NMR spectrum obtained as part of verifying the identity of the tri-furan functionalized compound (TMPA-3F) synthesized as described in the context of FIG. 8. ¹H NMR: (500 MHz, CDCl₃, δ): 7.36 (d, 1H; OCH), 6.30 (t, 1H; CH), 6.20 (d, 1H; CH), 4.03 (s, 2H; CCHS), 3.73 (s, 2H; OCH₂), 2.75 (t, 2H; SCH₂), 2.56 (t, 2H; CH₂CO), 1.46 (q, 2H; CH₂), 0.88 (t, 3H; CH₃).

A thermoset polymer (3F-2M) was synthesized in accordance to the reaction scheme presented in FIG. 3, and using the reactant monomers depicted in FIG. 7. A stoichiometric ratio of TMPA-3F, synthesized as described above, and BMI-1700, a 1,2-bis(octylmaleimide)-3-octyl-4-hexyl)cyclohexyl oligomer, was purchased from Designer Molecules, were mixed at 120° C. under constant stirring for 30 minutes before pouring into a mold. The resulting polymer was later cooled down to room temperature slowly in the mold before it was ready for FFF printing.

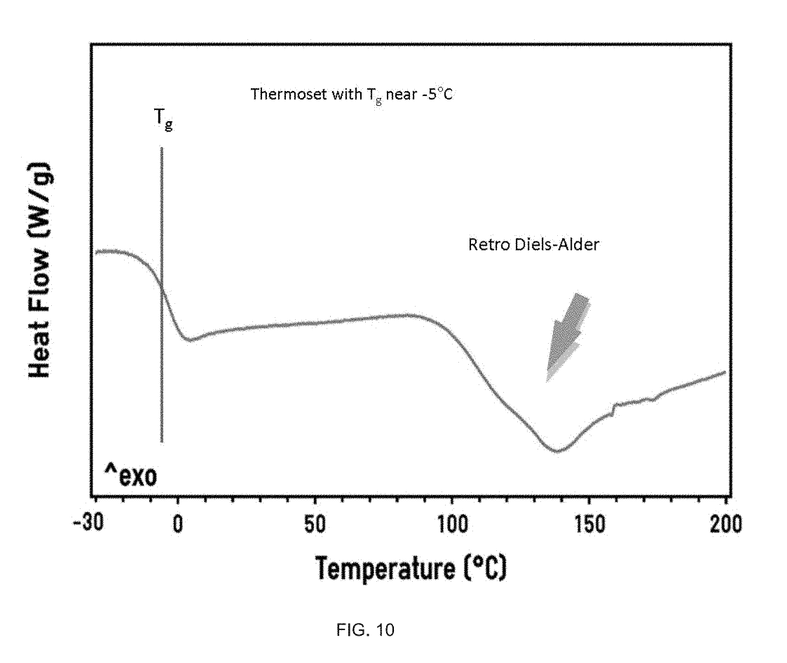

FIG. 10 presents example DSC scans of an embodiment of the thermoset polymer (3F-2M) formed in the furan-maleimide Diels-Alder reaction of the reactants shown in FIG. 7 in accordance with the reaction scheme shown in FIG. 3.

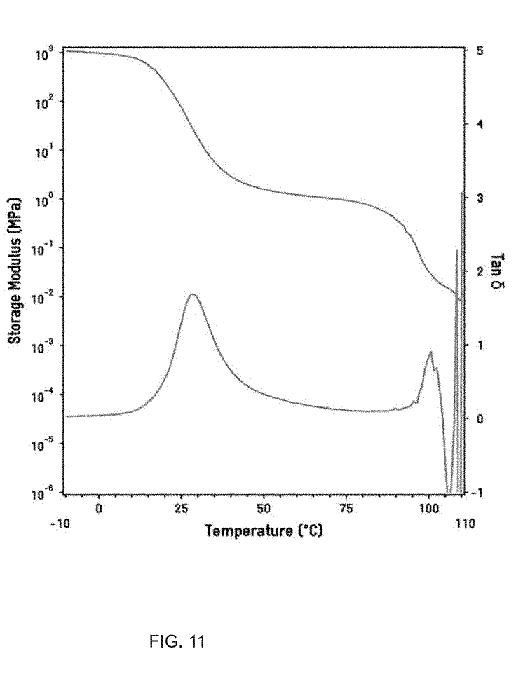

FIG. 11 presents example DMA scans of an embodiment of the thermoset polymer (3F-2M) formed in the furan-maleimide Diels-Alder reaction of the reactants shown in FIG. 7 in accordance with the reaction scheme shown in FIG. 3.

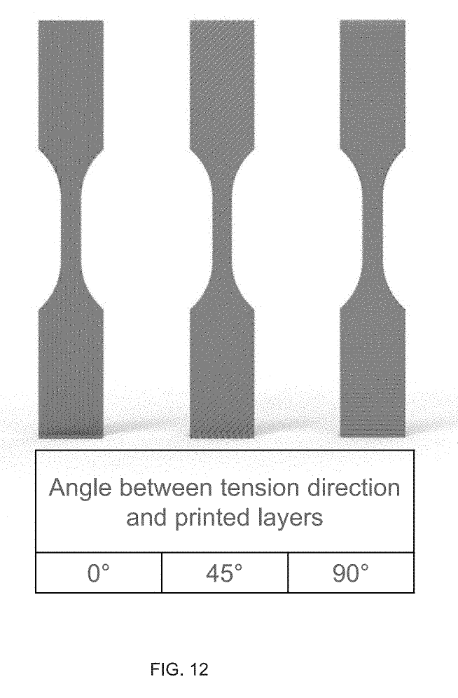

FIG. 12 presents example cut-out dog-bone samples showing cuts along different layer directions with different angles (0°, 45° and 90°) between the tension direction and the printed layer as presented in the figure, of FFF-printed polymer layers of the thermoset polymer (3F-2M) formed in the furan-maleimide Diels-Alder reaction of the reactants shown in FIG. 7, for use in tensile testing. To compare the properties between FFF printed parts and their corresponding neat polymers, neat samples molded from a Carver Press were also tested.

Tensile testing was conducted to failure, performed on a Lloyd LR5KPlus Universal Materials Testing Machine with a 100 N load cell. Dog-bone samples were punched out of the 3D printed sheets or compression molded sheets by Carver Press with an ASTM D638 Type V dog-bone die. Typically 10 specimens were prepared and tested for each sample. Dog-bones were held between Lloyd TG22 self-tightening roller grips within a Eurotherm Thermal Chamber. The strain was measured by a Lloyd Laserscan 200 non-contacting laser extensometer. Each test was done at room temperature (19° C.) at 50 mm/min, with a preload of 0.2 N. The toughness was determined as the integration of the area under the stress-strain curve.

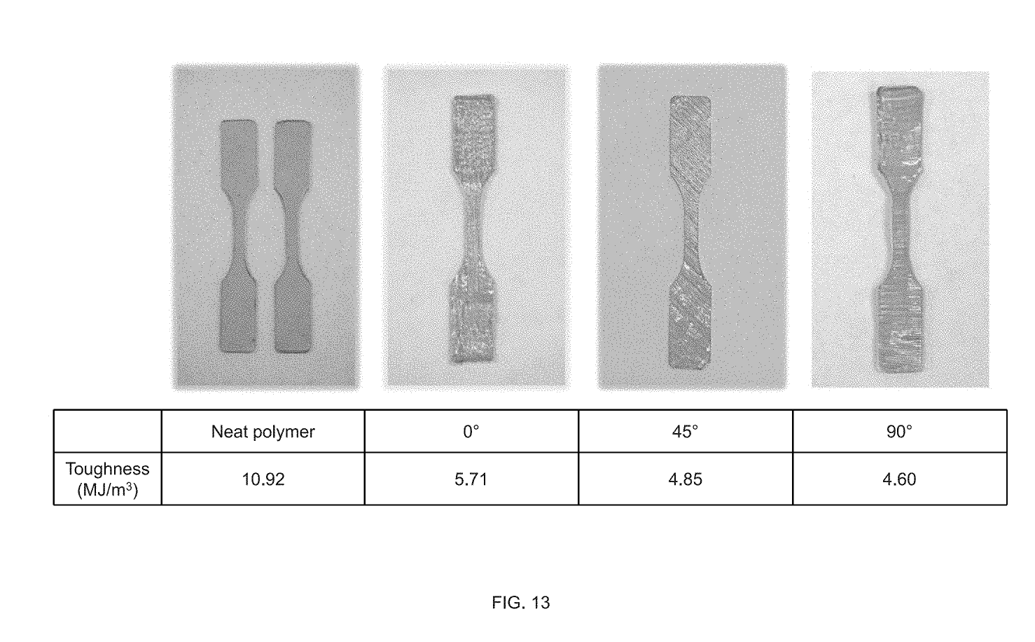

FIG. 13 presents example toughness measurements of the dog-bone samples described in the context of FIG. 12. Substantially the same toughness were measured for angles of 0°, 45° and 90°. For reference, a same-sized dog bone sample composed of polylactic acid (PLA) had measured toughness of 5.94 MJ/m³) and 2.05 MJ/m³ for angles of 0° and 90°, respectively.

Additional measurements were performed on additional samples of the thermoset polymer (3F-2M) as well as commercial samples of NinjaFlex® (NF) and SemiFlex™ (SF) both purchased from NinjaTek™ as filaments. The thermoset polymer (3F-2M) was printed on a modified 3Drag printer purchased from Futura Group. The print head was modified into a syringe type print head. Heating and cooling system were installed to facilitate controlled heating and cooling during the printing. NF and SF were printed on a Lulzbot TAZ 5 3D printer at 230° C. and 225° C. with the print bed at 40° C. and 95° C.

The modified 3Drag printer and process allowed for printing of thermoset polymer (3F-2M) as a solid rectangular prism having dimension of about 67 mm tall, about 60 mm wide and about 1.5 mm thick in about 12 to 14 minutes. In comparison, the printing of same-dimension samples of NF and SF using the Lulzbot TAZ 5 3D printer took more than twice as long.

Both neat and 3D printed samples of three materials were characterized with differential scanning calorimetry (DSC), dynamic mechanical analysis (DMA) and tensile testing (stress-strain curves).

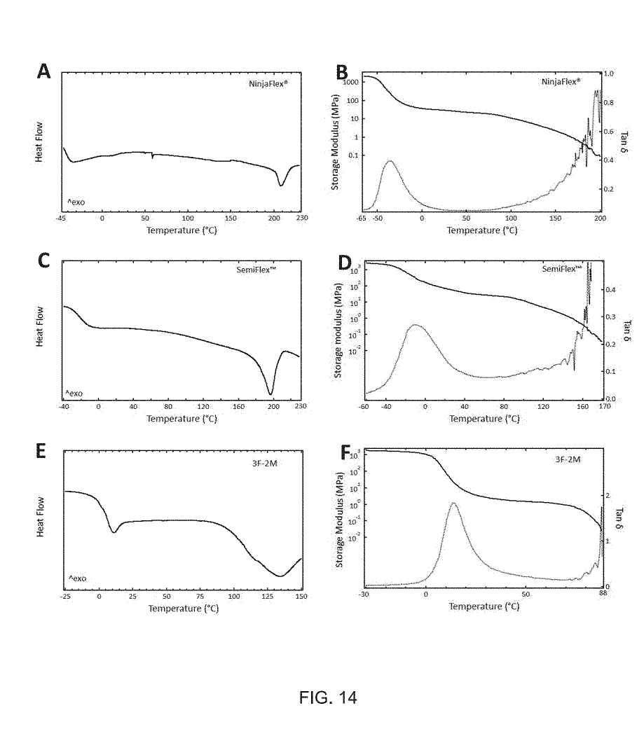

FIG. 14 presents example DSC and DMA scans of embodiments of NinjaFlex® (A and B, respectively), SemiFlex™ (C and D, respectively) and the thermoset polymer (3F-2M) synthesized as disclosed herein (E and F respectively).

The DSC curves shown in FIGS. 14C and 14E show that the glass transition temperatures (T_{g}) for SemiFlex™ and 3F-2M are −24° C. and 6.5° C., respectively. As illustrated in FIG. 14A the T_{g} of NinjaFlex® was not conclusively measured since it was too low for the DSC scan to detect the whole transition (onset below −50° C.). The DSC data indicate that all three materials were elastomers at room temperature. DSC curves of NinjaFlex® and SemiFlex™ showed an endothermic transition at 208° C. and 198° C., respectively, corresponding to their melting points. The DSC curve of 3F-2M shown in FIG. 14E showed a wide endothermic transition with the onset temperature at 92° C., corresponding to the retro-Diels-Alder reaction.

The DMA curves of NinjaFlex®, SemiFlex™ and 3F-2M are described in FIGS. 14B, 14D and 14F, respectively, each of which has the modulus and tangent delta superimposed in the function of temperature. NinjaFlex® had a T_{g} near −36° C. and SemiFlex™ had a T_{g} near −10° C., as indicated by the peaks of tangent delta. After the glass transition, both moduli kept dropping and eventually dropped below 0.1 MPa as the temperature reached 170° C. The curves of modulus and tangent delta demonstrated high variability at higher temperatures, indicating both NinjaFlex® and SemiFlex™ samples entered polymer melt flow zone and confirming their thermoplastic property. The peak of tangent delta curve in FIG. 14F shows that 3F-2M had a T_{g} near 14° C. After the glass transition, the 3F-2M sample entered a rubbery plateau at about 35° C., with modulus staying at about 1 MPa until the temperature reached 70° C., when the modulus dramatically dropped below 0.1 MPa within 15° C. range and demonstrated large variability upon further heating. This confirms that below 70° C. 3F-2M retained thermoset behavior, but at higher temperatures where the retro-Diels-Alder reaction can occur, the polymer de-crosslinked and became melt-processable similar to a thermoplastic.

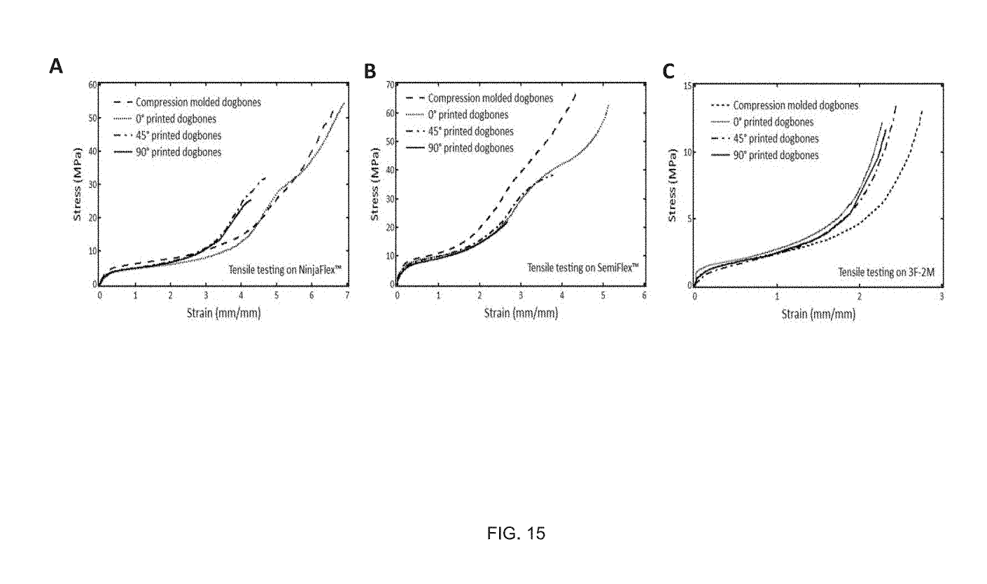

Tensile testing of dog-bone samples of FFF printed parts from NinjaFlex®, SemiFlex™ and the thermoset polymer (3F-2M) was done in the same manner as described in the context of FIGS. 12 and 13 for three different layer directions, 0°, 45° and 90°. FIG. 15 presents example stress-strain curves for dog-bone compression molded and FFF printed sample embodiments of A) NinjaFlex®, B) SemiFlex™ and C) the thermoset polymer (3F-2M).

As illustrated in FIGS. 15A and 15B, both the compression molded NinjaFlex® and SemiFlex™ samples showed a slightly lower ultimate tensile strength and failure strain compared to the 0° printed samples, possibly due to the loss of crystallinity during the compression molding. The FFF printed NinjaFlex® and SemiFlex™ dog-bone samples exhibited anisotropy. For instance, 0° printed NinjaFlex® had a tensile stress of 54.48 MPa at a failure strain of 692.86%, while 45° and 90° printed NinjaFlex® samples had a tensile stress of 31.83 MPa at a failure strain of 469.06% and 22.9 MPa at a failure strain of about 480%, respectively. The NinjaFlex® average toughness of the 45° printed sample was 53.58 MJ/m³, which was about 46% of the toughness of the 0° printed sample, 116.27 MJ/m³, whereas the average toughness of the 90° printed sample was 40.48 MJ/m³, nearly 34% of the toughness of the 0° printed sample. For instance, a 0° printed SemiFlex™ sample had a tensile stress of 62.82 MPa at a failure strain of 513%, while 45° and 90° printed SemiFlex™ samples had a tensile stress of 38.24 MPa at a failure strain of 378% and 21.94 MPa at a failure strain of 268%, respectively. The average SemiFlex™ toughness of the 45° printed sample was 69.25 MJ/m³, 50% of the toughness of the 0° printed sample, 137.42 MJ/m³ whereas the average toughness of the 90° printed sample was 36.21 MJ/m³, 26% of the toughness of the 0° printed sample.

As illustrated in FIG. 15C, 0° printed thermoset polymer (3F-2M) samples had a tensile stress of 12.25 MPa at a failure strain of about 228%, while the 45° and 90° printed samples had a tensile stress of 13.57 MPa at a failure strain of 244% and 11.70 MPa at a failure strain of about 232%, respectively. The average toughness of the 45° printed sample was 9.16 MJ/m³, nearly 99% of the toughness of the 0° printed sample, 9.27 MJ/m³ whereas the average toughness of the 90° printed sample was 8.81 MJ/m³, approximately 95% of the toughness of the 0° printed sample.

TABLE 1 presents a comparison of the toughness of Neat and FFF printable engineering materials, NinjaFlex® (NF), SemiFlex™ (SF), and literature values for polylactic acid (PLA) polymer (see J. R. Davidson, G. A. Appuhamillage, C. M. Thompson, W. Voit, R. A. Smaldone, ACS Appl. Mater. Interfaces 2016, 8, 16961-16966) and acrylonitrile butadiene styrene (ABS) polymer (see S. Shaffer, K. Yang, J. Vargas, M. A. Di Prima, W. Voit, Polymer 2014, 55, 5969-5979) to the thermoset polymer (3F-2M) synthesized as disclosed herein.

TABLE 1
Comparison the toughness values (mean ± SD MJ/m³) for neat and FFF
printed polymers and ratios of toughness

| | Neat polymer | 0° | 45° | 45°/10° | 90° | 90°/0° |
|---|---|---|---|---|---|---|
| NF | 114.45 ± 9.67 | 116.27 ± 20.43 | 53.58 ± 7.06 | 46% | 40.92 ± 4.61 | 35% |
| SF | 117.33 ± 19.11 | 137.42 ± 15.53 | 69.25 ± 9.84 | 50% | 36.21 ± 5.30 | 26% |
| PLA | NA | 0.23 ± 0.03 | NA | NA | 0.05 ± 0.02 | 22% |
| ABS | NA | 6.93 | 0.53 | 8% | 0.17 | 2% |
| 3F-2M | 10.92 ± 1.78 | 9.27 ± 2.48 | 9.16 ± 2.55 | 99% | 8.81 ± 2.70 | 95% |

As illustrated in TABLE 1 and FIG. 15C, the FFF printed thermoset polymer (3F-2M) has substantially less mechanical anisotropy as compared to the commercially available NinjaFlex®, SemiFlex™ and acrylonitrile butadiene styrene polymers.

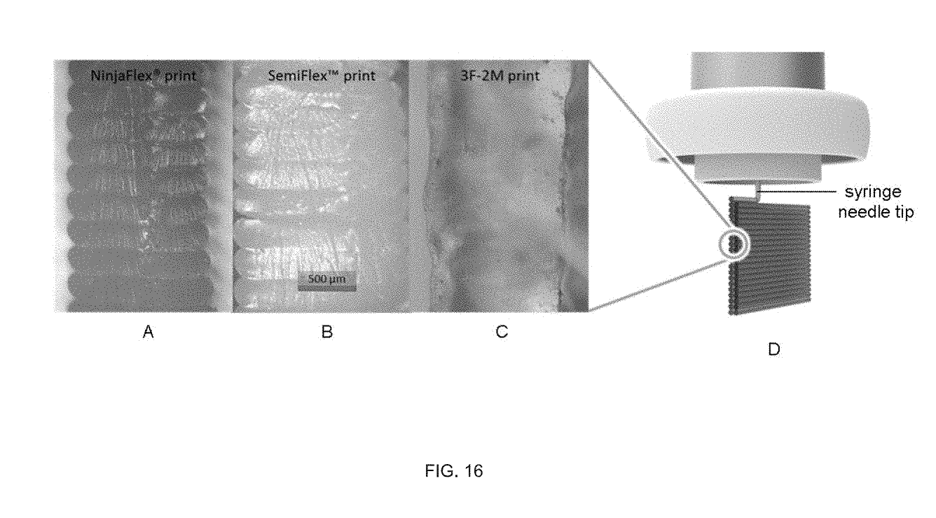

FIG. 16 shows detailed photographic cross-section views of portions FFF printed parts from: A) NinjaFlex®, B) SemiFlex™ and C) thermoset polymer (3F-2M), the detailed views corresponding to the circled portion shown in FIG. 16D. While distinct layers are clearly visible in the printed parts of NinjaFlex® and SemiFlex™, no such layers are discernable in the printed part of 3F-2M. We attribute this to the layers in the 3F-2M printed parts being re-mended and fused together through Diels-Alder chemistry, which in turn is thought to lead to the desirable isotropic mechanical properties of the printed part.

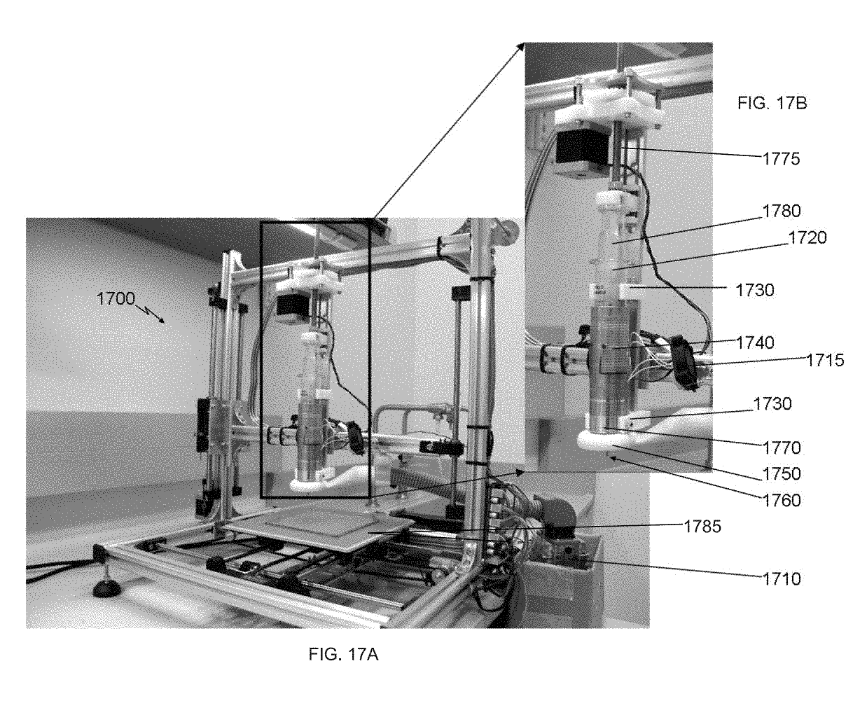

FIG. 17A presents a photograph of a printer adapted to FFF print the Diels-Alder synthesized thermoset polymer (3F-2M) and the inset photograph (FIG. 17B) presents a detailed view of the syringe portion of the printer. Due to its ability to rapidly FFF print polymer parts from the Diels-Alder synthesized thermoset polymers synthesized as described herein, we named this modified printer a Diels-Alder Rapid Extrusion (DARE) Printer 1700.

With continuing reference to FIGS. 17A and 17B throughout, embodiments of the printer 1700 can include: cooling systems (a Peltier cell cooling system 1710 and/or a fan cooling system 1715), a syringe-type print extruder head 1720, syringe mounts 1730 (e.g., composed of teflon, to replace original Delrin parts, to provide better thermal stability), a heating coil 1740 (e.g., encapsulated in Kapton tape) wrapped around the syringe-type print extruder head 1720, a duct 1750 (e.g., 3D printed polycarbonate) and syringe needle 1760 for extruding a melted filament of the Diels-Alder synthesized thermoset polymers to form 3D printed polymer parts (see e.g., FIG. 16D).

The modified DARE printer 1700 was developed in response to the impractically of feeding and extruding pre-formed filaments of Diels-Alder synthesized thermoset polymers through commercial extruder print heads. For polymer filaments to be printed on commercial extruder print heads, they need to be able to melt fast enough so the polymer can be melted at the tip of the hot end while the filament above the hot end stays solid so as to be able to push the melt out of the extruder nozzle.

As noted elsewhere herein, the fmDA cross-link within the network are not completely reversed at a given temperature, but rather are in equilibrium. In some embodiments, this means that the de-cross-linking process (e.g., melting of the fmDA polymers) is slow. While the de-cross-linking process could be speed up by increasing the temperature, in some embodiments, only about 20%-30% of fmDA linkages undergo retro-cycloaddition, and, higher temperatures increase the risk of side reactions, such as aromatization of the DA adducts, ring-opening of furfuryl rings and homopolymerization of maleimides, causing the loss of reversibility of crosslinks, as well as polymer degradation.

Achieving a balance of maximal disassociation of the thermoset polymer and minimal degradation of the reactants was facilitated by replacing the commercial printer extruder head with the syringe-type print extruder head 1720 and adding the additional components disclosed above.

In some embodiments, a method of FFF printing using the melt-processable thermoset polymers synthesized as disclosed herein include loading the polymer into the syringe-type print extruder head 1720. The syringe-type print extruder head 1720 was heated to a desired melting temperature (e.g., about 90° C. in some embodiments) via the heating coil 1740 wrapped around a metal (e.g., aluminum) syringe sleeve 1770 that the syringe 1720 is held in. After the polymer in the syringe 1720 melts, a piston 1775 of the printer 1700 pushes down the piston 1780 of the syringe 1720 to deposit the polymer melt onto a print bed 1785 via the syringe needle 1760. In some embodiments, one or both of the cooling systems 1710, 1715 can be activated through the end of printing to facilitate the proper cooling of the printed part during the printing. In some embodiments, the printed part (see e.g., FIG. 16C) can be post-cured at room temperature (e.g., 23° C.) or annealed higher temperatures (e.g., up to 60° C.) for about 12 to 24 hours before mechanical testing, such as disclosure elsewhere herein.

In some embodiments, a computer program (e.g., written on open-source software such as Repetier) can be used to facilitate controlling the temperature of the heating coil 1740, and, during the printing, control when the cooling system 1710 starts to cool and/or further control the fan cooling system 1715 to blow cooling air through the pipe and the duct then onto the printed part.

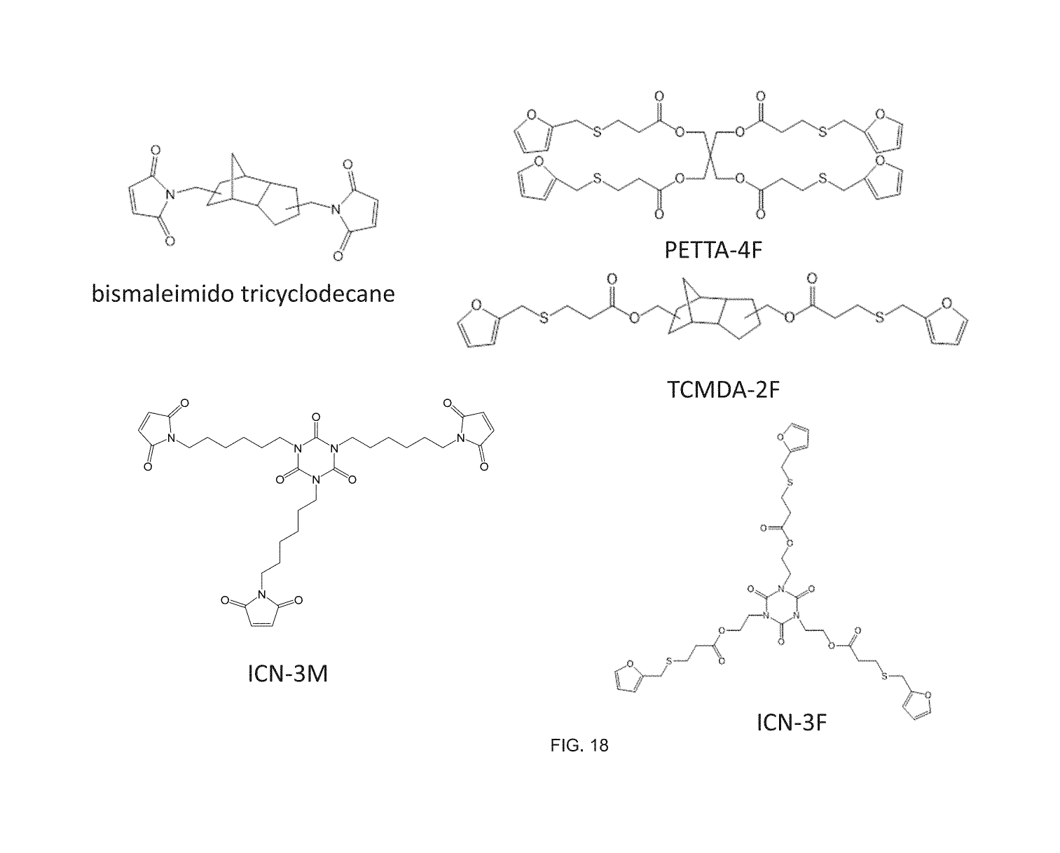

FIG. 18 presents schematic representations of additional furan functionalized monomers PETTA-4F, bis[2-[3-(2-furanylmethyl)thio]propionyloxy]ethyl] tricyclodecane (TCMDA-2F) and tris[(6-maleimido)hexyl] isocyanurate (ICN-3F) and maleimide functionalized monomer (bismaleimido tricyclodecane and tris[2-[3-(2-furanylmethyl)thio]propionyloxy]ethyl] isocyanurate (ICN-3M) which, when reacted in a furan-maleimide Diels-Alder reaction, can form a thermoset polymer in accordance with the reaction scheme shown in FIG. 3.

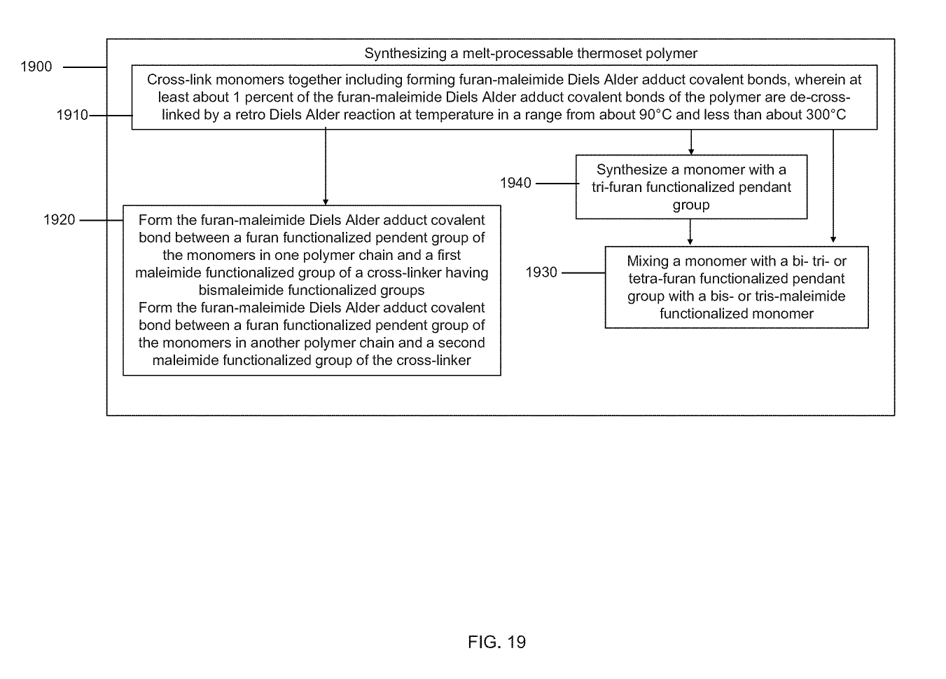

FIG. 19 presents a flow diagram of an example method 1900 of synthesizing a melt-processable thermoset polymer, including any of the melt-processable thermoset polymer embodiments disclosed in the context of FIGS. 1-18. The example method 1900 can comprise cross-linking monomers together (step 1910) including forming furan-maleimide Diels Alder adduct covalent bonds. At least about 1 percent, and in some embodiments at least about 20 percent and in some embodiments at least about 30 percent, and in some embodiments less than about percent of the furan-maleimide Diels Alder adduct covalent bonds of the polymer are de-cross-linked by a retro Diels Alder reaction at temperature in a range from about 90° C. and less than about 300° C.

In some embodiments where lower crosslink density is desired, to facilitate crystal formation or to form elastomeric materials) is desired, then a melt-processable thermoset polymer may be formed with at least about 1 percent de-cross-linking. Consider embodiments using a tri functional and a di functional maleimide monomer reacting with a di functional monomer (e.g., Furan). Some of the crosslinks would be cleaved and some of the chains would be cleaved. In some such embodiments, if the amount of crosslinking (tri functional or higher) molecules is, e.g. less than about 10 percent, then the amount of the trifunctional crosslinks needed to break to form a melt-processable thermoset polymer may much less than the total number of crosslinking bonds in the system (e.g., at least about 1 percent decrosslinking). In some embodiments, e.g., using a di functional maleimide and a trifunctional furan, at least about 20% decrosslinking, may be required.

In some embodiments, cross-linking the monomers together (step 1910) includes a step 1920 of forming the furan-maleimide Diels Alder adduct covalent bond between a furan functionalized pendent group of the monomers in one polymer chain and a first maleimide functionalized group of a cross-linker having bismaleimide functionalized groups, and, forming the furan-maleimide Diels Alder adduct covalent bond between a furan functionalized pendent group of the monomers in another polymer chain and a second maleimide functionalized group of the cross-linker. For instance, as part of step 1920, the polymer chains having the monomers with the furan functionalized pendent groups is a Poly(Furfuryl MethAcrylate-co-Ethyl MethAcrylate) polymer and the cross-linker is Methylenedi-phenylene bismaleimide.

Alternatively, in some embodiments cross-linking the monomers together (step 1910) includes a step 1930 of mixing a monomer with a bi- tri- or tetra-furan functionalized pendant group with a bis- or tris-maleimide functionalized monomer. For example in various embodiments as part of step 1930, the bis- or tris-maleimide functionalized monomer is bismaleimido tricyclodecane or ICN-3M and the monomer with the bi- tri- or tetra-furan functionalized pendant group is TCMDA-2F, ICN-3F or PETTA-4F (see e.g., FIG. 18).

In some embodiments, e.g., prior to mixing step 1930, the method 1900 can further include a step 1940 of synthesizing the monomer with the tri-furan functionalized pendant group. As a non-limiting example synthesizing (step 1940) can include dissolving trimethylolpropane triacrylate in dichloromethane containing triethylene amine to form a solution, adding furfuryl mercaptan to the solution to form a mixture and drying the mixture to remove unreacted furfuryl mercaptan and yield a tri-furan functionalized trimethylolpropane triacrylate monomer. Based on this example one skilled in the pertinent art would understand how other monomers with multi-furan functionalized pendant groups (e.g., monomers with bi- or tetra-furan functionalized pendant groups) could be synthesized by procedures analogous to that described for step 1940.

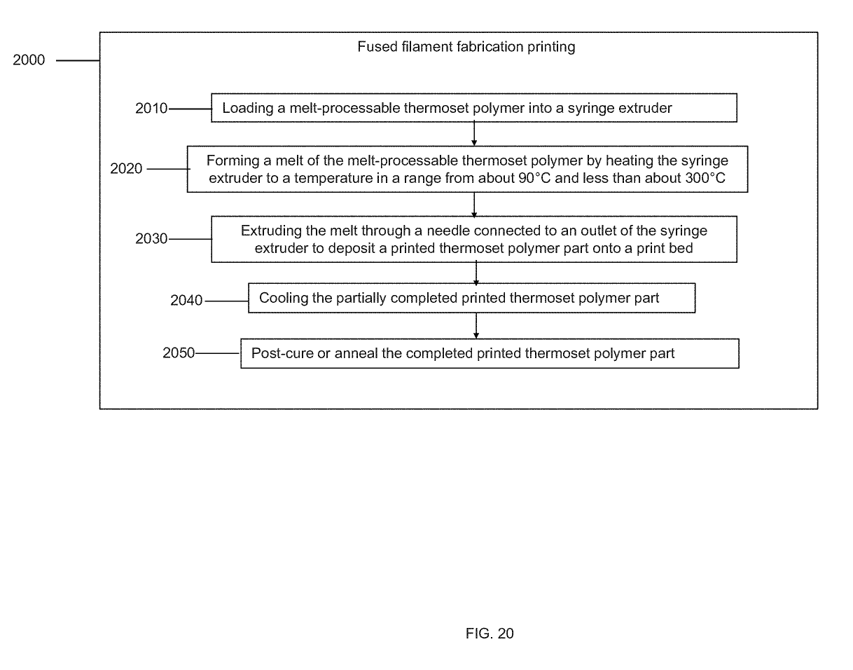

FIG. 20 presents a flow diagram of an example method 2000 of fused filament fabrication printing, including printing a thermoset polymer part that includes any of the melt-processable thermoset polymer embodiments disclosed in the context of FIGS. 1-19.

The example method 2000 can comprise loading a melt-processable thermoset polymer into a syringe extruder (step 2010). For instance, the melt-processable thermoset polymer can include monomers cross-linked together by furan-maleimide Diels Alder adduct covalent bonds, wherein least about 1 percent, and in some embodiments at least about 20 percent and in some embodiments at least about 30 percent, and in some embodiments less than about 40 percent, of the furan-maleimide Diels Alder adduct covalent bonds of the polymer are de-cross-linked by a retro Diels Alder reaction in the temperature range.

The method 200 can further comprise forming a melt (step 2020) of the melt-processable thermoset polymer by heating the syringe extruder to a temperature in a range from about 90° C. and less than about 300° C. The method 2000 can also comprise extruding the melt through a needle connected to an outlet of the syringe extruder to deposit a printed thermoset polymer part onto a print bed (step 2030).

Some embodiments of the method 2000 can further include cooling the partially completed printed thermoset polymer part (step 2040), e.g., after the polymer melt is extruded the needle as part of step 2030.

Some embodiments of the method 2000 can further include post curing or annealing the completed printed thermoset polymer part (step 2050).

Those skilled in the pertinent arts to which this application relates will appreciate that other and further additions, deletions, substitutions and modifications may be made to the described embodiments.

1. A melt-processable thermoset polymer, comprising:
monomers cross-linked together by furan-maleimide Diels Alder adduct covalent bonds, wherein at least about 1 percent of the furan-maleimide Diels Alder adduct covalent bonds of the polymer are de-cross-linked by a retro Diels Alder reaction at a temperature in a range from about 90° C. and less than about 300° C.

2. The polymer of claim 1, wherein the monomers are included in polymer chains having furan functionalized pendent groups cross-linked together by:
the furan-maleimide Diels Alder adduct covalent bond formed between a furan functionalized pendent group of one polymer chain and a first maleimide functionalized group of a cross-linker having bismaleimide functionalized groups and
the furan-maleimide Diels Alder adduct covalent bond formed between a furan functionalized pendent group of another polymer chain and a second maleimide functionalized group of the cross-linker.

3. The polymer of claim 2, wherein the polymer chains having the furan functionalized pendent groups is a Poly(Furfuryl MethAcrylate-co-Ethyl MethAcrylate) polymer and the cross-linker is Methylenedi-phenylene bismaleimide.

4. The polymer of claim 1, wherein the monomers include a monomer with a bi- tri- or tetra-furan functionalized pendant group and another monomer with a bis- or tris-maleimide functionalized pendant group.

5. The polymer of claim 4, wherein the other monomer with the bis- or tris-maleimide functionalized pendant group is bismaleimido tricyclodecane or tris[(6-maleimido)hexyl] isocyanurate and the monomer with the bi- tri- or tetra-furan functionalized pendant group is bis[2-[3-(2-furanylmethyl)thio]propionyloxy]ethyl] tricyclodecane, tris[2-[3-(2-furanylmethyl)thio]propionyloxy]ethyl] isocyanurate or PETTA-4F.

6. A method of synthesizing a melt-processable thermoset polymer, comprising:
cross-linking monomers together including forming furan-maleimide Diels Alder adduct covalent bonds, wherein at least about 1 percent of the furan-maleimide Diels Alder adduct covalent bonds of the polymer are de-cross-linked by a retro Diels Alder reaction at temperature in a range from about 90° C. and less than about 300° C.

7. The method of claim 6, wherein cross-linking the monomers together includes:
forming the furan-maleimide Diels Alder adduct covalent bond between a furan functionalized pendent group of the monomers in one polymer chain and a first maleimide functionalized group of a cross-linker having bismaleimide functionalized groups; and
forming the furan-maleimide Diels Alder adduct covalent bond between a furan functionalized pendent group of the monomers in another polymer chain and a second maleimide functionalized group of the cross-linker.

8. The method of claim 7, wherein the polymer chains having the monomers with the furan functionalized pendent groups is a Poly(Furfuryl MethAcrylate-co-Ethyl MethAcrylate) polymer and the cross-linker is Methylenedi-phenylene bismaleimide.

9. The method of claim 6, wherein the cross-linking of the monomers together includes mixing a monomer with a bi- tri- or tetra-furan functionalized pendant group with another monomer with a bis- or tris-maleimide functionalized pendant group.

10. The method of claim 9, wherein the other monomer with the bis- or tris-maleimide functionalized pendant group is bismaleimido tricyclodecane or ICN-3M and the monomer with the bi- tri- or tetra-furan functionalized pendant group is TCMDA-2F, ICN-3F or PETTA-4F.

11. The method of claim 9, further including synthesizing the monomer with the tri-furan functionalized pendant group, including:
dissolving trimethylolpropane triacrylate in dichloromethane containing triethylene amine to form a solution;
adding furfuryl mercaptan to the solution to form a mixture;
drying the mixture to remove unreacted furfuryl mercaptan and yield a tri-furan functionalized trimethylolpropane triacrylate monomer.

12. A filament fabrication printer, comprising:
a syringe extruder;
a needle connected to an outlet of the syringe extruder; and
a heating coil wrapped around the syringe extruder, the heating coil configured to heat a melt-processable thermoset polymer held in the syringe extruder to a temperature in a range from about 90° C. and less than about 300° C.

13. The printer of claim 12, wherein the melt-processable thermoset polymer includes monomers cross-linked together by furan-maleimide Diels Alder adduct covalent bonds, wherein at least about 1 percent of the furan-maleimide Diels Alder adduct covalent bonds of the polymer are de-cross-linked by a retro Diels Alder reaction in the temperature range.

14. The printer of claim 12, further including a piston configured the push a piston of the syringe extruder to thereby extrude a melt of the melt-processable thermoset polymer through the needle and to deposit a printed thermoset polymer part onto a bed of the printer.

15. The printer of claim 13, wherein the monomers of the melt-processable thermoset polymer include:
a monomer with a bi-furan functionalized pendant group and another monomer with a bis- or tris-maleimide functionalized pendant group, or,
a monomer with a bi- tri- or tetra-furan functionalized pendant group and another monomer with a bis-maleimide functionalized pendant group, or,
a monomer with a bi-furan functionalized pendant group and another monomer with a bis-maleimide functionalized pendant group.

16. (canceled)

17. A method of fused filament fabrication printing, comprising:
loading a melt-processable thermoset polymer into a syringe extruder;
forming a melt of the melt-processable thermoset polymer by heating the syringe extruder to a temperature in a range from about 90° C. and less than about 300° C.; and
extruding the melt through a needle connected to an outlet of the syringe extruder to deposit a printed thermoset polymer part onto a print bed.

18. The method of claim 17, wherein the melt-processable thermoset polymer includes monomers cross-linked together by furan-maleimide Diels Alder adduct covalent bonds, wherein at least about 1 percent of the furan-maleimide Diels Alder adduct covalent bonds of the polymer are de-cross-linked by a retro Diels Alder reaction in the temperature range.

19. The method of claim 18, wherein the monomers of the melt-processable thermoset polymer include:
a monomer with a bi-furan functionalized pendant group and another monomer with a bis- or tris-maleimide functionalized pendant group, or,
a monomer with a bi- tri- or tetra-furan functionalized pendant group and another monomer with a bis-maleimide functionalized pendant group, or,
a monomer with a bi-furan functionalized pendant group and another monomer with a bis-maleimide functionalized pendant group.

20. The method of claim 17, further including post-curing or annealing the completed printed thermoset polymer part.

21. The polymer of claim 1, wherein the monomers include:
a monomer with a bi-furan functionalized pendant group and another monomer with a bis- or tris-maleimide functionalized pendant group, or,
a monomer with a bi- tri- or tetra-furan functionalized pendant group and another monomer with a bis-maleimide functionalized pendant group, or,
a monomer with a bi-furan functionalized pendant group and another monomer with a bis-maleimide functionalized pendant group.
